(19) United States
(12) Patent Application Publication
(10) Pub. No.: US 2012/0111643 A1
(43) Pub. Date: May 10, 2012

(54) METHOD AND APPARATUS FOR WEIGHING A PERSON

(76) Inventor: Ralf LINDNER, Duesseldorf (DE)

(21) Appl. No.: 13/017,975

(22) Filed: Jan. 31, 2011

(30) Foreign Application Priority Data
Nov. 5, 2010 (DE) 102010050330.4
Nov. 5, 2010 (DE) 102010050332.0

(51) Int. Cl. G01G 9/00; G01G 23/30

(52) U.S. Cl. 177/1; 177/177

(57) ABSTRACT

An apparatus for weighing a person has a platform, at least one weight sensor connected to the platform for producing an output corresponding to a weight applied to the platform, a display, and control means connected to the sensor and to the display for comparing the output with a stored target value, for calculating a difference between the output and stored value, and for displaying data on the display corresponding to a the calculated difference.

### FIELD OF THE INVENTION

The present invention relates to a method of and apparatus for weighing a person. More particularly this invention concerns a personal scale and weighing system particularly adapted for determining a ratio of body fat.

### BACKGROUND OF THE INVENTION

An apparatus or scale of this type for weighing a person are generally known and part of standard bathroom fixtures because the average person often monitors his weight there in connection with his personal grooming routine.

Since in an average family of three or four people a bathroom is often used by several people at the same time, it is seen as a problem, however, that it is often not possible to weigh oneself on the scales discreetly if another member of the family is present, since the display on a scale according to the prior art can usually also be read from a distance.

### OBJECTS OF THE INVENTION

It is therefore an object of the present invention to provide an improved method and apparatus for weighing a person.

Another object is the provision of such an improved method and apparatus for weighing a person that overcomes the above-given disadvantages, in particular that also takes into account the user's need for greater privacy.

### SUMMARY OF THE INVENTION

An apparatus for weighing a person has according to the invention a platform, at least one weight sensor connected to the platform for producing an output corresponding to a weight applied to the platform, a display, and control means connected to the sensor and to the display for comparing the output with a stored target value, for calculating a difference between the output and stored value, and for displaying data on the display corresponding to a the calculated difference.

The essential advantage of the apparatus according to the invention is that a discreet use is also possible with it in the common case that a bathroom scale is used by several people, since the scale itself displays only a difference value between a personal target value and the measured value. The actual weight is not discernible by an accidental viewer of the display.

In an advantageous embodiment of the invention, the apparatus is suitable not only for the entry of at least one target value also for the entry of several target values of different people. This way advantageously allowance is made for the fact that a bathroom scale is generally used by several people in a family.

In another embodiment of the invention, the apparatus for entering at least one target value can be controlled by a hand or foot via touch sensors mounted on or under the platform. This makes possible a simple operation by hand or, when standing, even by foot (toes).

In another advantageous embodiment of the invention, for the purpose of the additional optical display and evaluation of the difference value, the optical display in a translucent platform is composed of at least one planar optical light guide. Rays or a beam of light are introduced into each optical light guide by means of at least one illumination apparatus or light source and at least most of the rays of light emerge at the end face of the optical light guides and through the platform in a manner visible to the viewer.

This embodiment has the additional advantage that in addition it is made clear to the user by an optical display whether the actually measured value is above or below the target value or is in the range of the target value.

In principle, this can be additionally supported according to a further embodiment of the invention in that the illumination apparatus emits rays of light of different colors in different directions.

Furthermore, the invention also relates to a method for displaying at least one measured value in an apparatus for weighing a person, in particular body analysis scales and body fat scales.

Based on the object described above, the solution of this object is distinguished by the following process steps:
setting a personal target value,
measuring the actual weight,
comparing the actual weight with the target value and determining a difference, and
displaying the difference.

The method according to the invention makes possible in an advantageous manner a discreet weight measurement when several people are present in a bathroom at the same time, without the actual weight being revealed to the people additionally present.

In an advantageous embodiment of the method, the display shows the actual value is above or below the target value or essentially corresponds to the target value.

### BRIEF DESCRIPTION OF THE DRAWING

The above and other objects, features, and advantages will become more readily apparent from the following description, reference being made to the accompanying drawing in which:

FIG. 1 is a top view of the apparatus according to the invention with outlines of a pair of feet for illustrations's sake;

FIGS. 2-4 are top views of the apparatus without the outlines and showing different displays;

FIG. 5 is an exploded view of the apparatus according to the invention;

FIG. 6 is a large-scale exploded view of a subassembly of the apparatus; and

FIG. 7 is a section taken along line VII-VII of FIG. 1.

### SPECIFIC DESCRIPTION

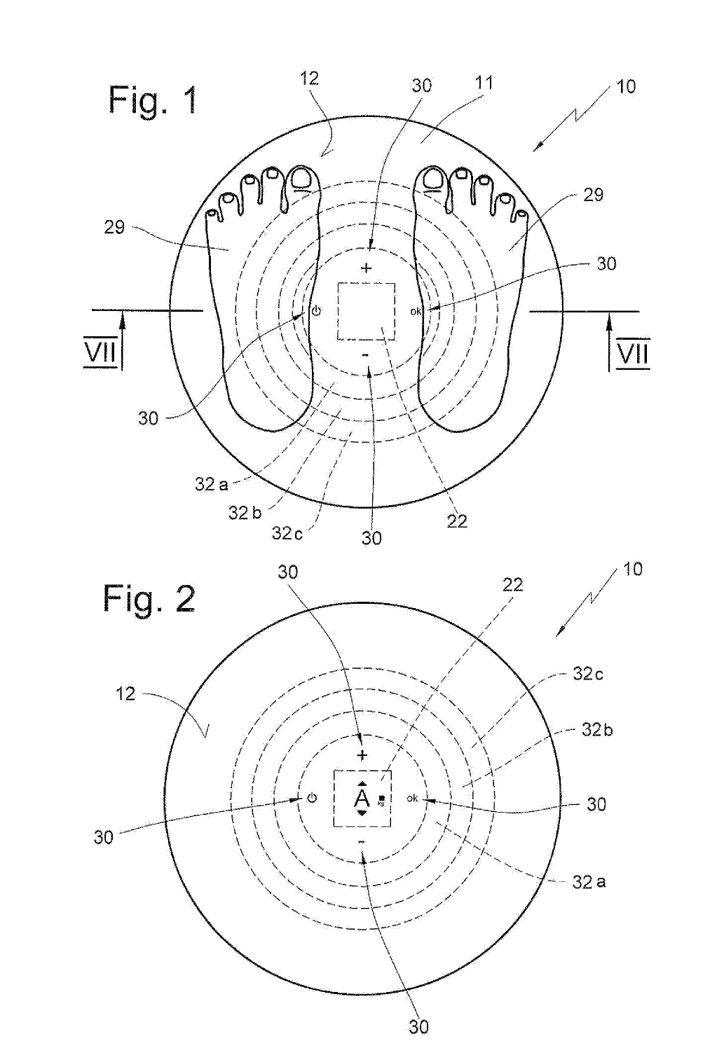

As seen in FIGS. 1, 5, 6, and 7 a weighing and weight-monitoring apparatus 10 according to the invention has a housing 11 with a platform 12 made of polycarbonate and centrally upwardly convexly domed with a part-spherical shape centered on a vertical central axis 11A. The platform 12 serving as cover is translucent and is coated with a translucent, preferably black paint. The housing 11 is supported by four angularly equispaced strain-gauge feet or weight sensors 14.

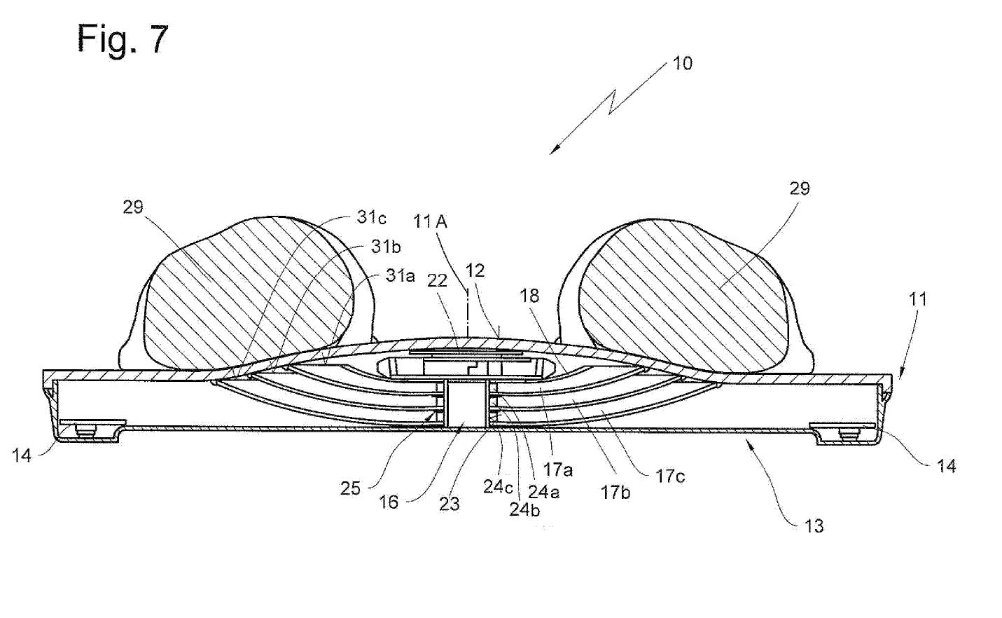

Inside, the apparatus 10 has a mushroom-shaped subassembly 15 described in detail below and having a central stem 16 centered on the axis 11A and engaging centrally through three slightly upwardly concave, vertically spaced, and part-spherical sheet-metal light guides 17a, 17b, 17c of increasing diameter from the uppermost guide 17a to the lowermost guide 17c. Outer edges 31a, 31b, 31c (FIG. 7) of the light guides 17a, 17b, 17c touch and support the bottom face of the cover/platform 19 so that circularly annular outer edge regions 32a, 32b, and 32c are exposed upwardly through this cover/platform 19. Top and bottom faces of the light guides 17a and 17b are mirrored as well as the upper face of the guide dish 17c.

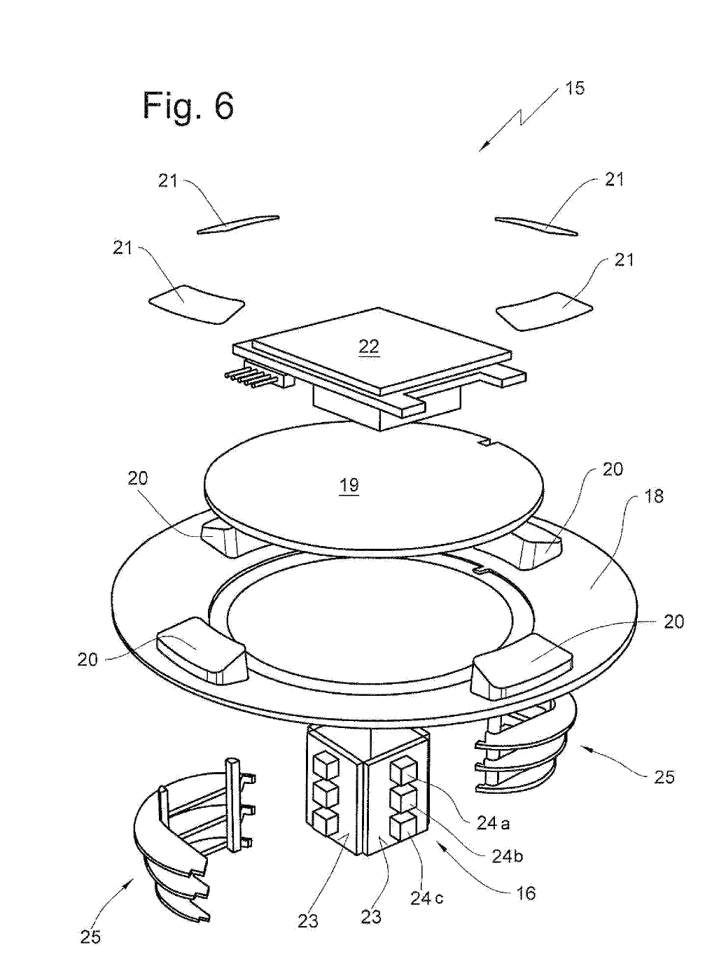

Above the stem 16, the mushroom-shaped subassembly 15 has as best seen in FIG. 6 a mounting ring 18 supporting a printed-circuit board 19 and four support feet 20 having respective touch sensors 21 and extending upward from the upper face of the mounting ring 18. The bottom face of this ring 18 is also mirrored for light-guiding purposes. These touch sensors 21 are simple switches engaged between the upper end face of the respective support foot 20 and the downwardly concave lower face of the platform 12 that is elastically deformable enough that the sensor switches 21 can be actuated by a light pressure over them on the upper face of the platform 12. Furthermore, there is a display module 22 above the circuit board 19 that can produce a display visible through the axial center of the translucent platform 12 in the assembled condition.

The stem 16, which is of square section seen vertically, is provided on each of its vertical and planar side faces 23 with three LEDs 24a, 24b, and 24c spaced one above the other and each having their own unillustrated operating circuit. Light emitted by the upper array of four LEDs 24a falls between the ring 18 and the upper guide 17a and is reflected upward as the ring 31a, light from the middle array of LEDs 24b falls between the upper guide 17a and the middle guide 17b and is reflected upward as the ring 32b, and light from the lower array of LEDs 24c falls between the middle guide 17b and the lower guide 17c and is reflected upward as the ring 32c. In addition the LEDs 24a, 24b, 24c of each array can be controlled individually to only light up a 90° segment of the respective light ring 32a, 32b, or 32c. The stem 16 has LED shield separator or shield plates 25 that separate the LEDs 24 from one another spatially and ensure clean irradiation of the light rays emitted by an LED 24 into the respective light guide 17a, 17b or 17c. The LED shields 25 are attached to the underside of the mounting ring 18.

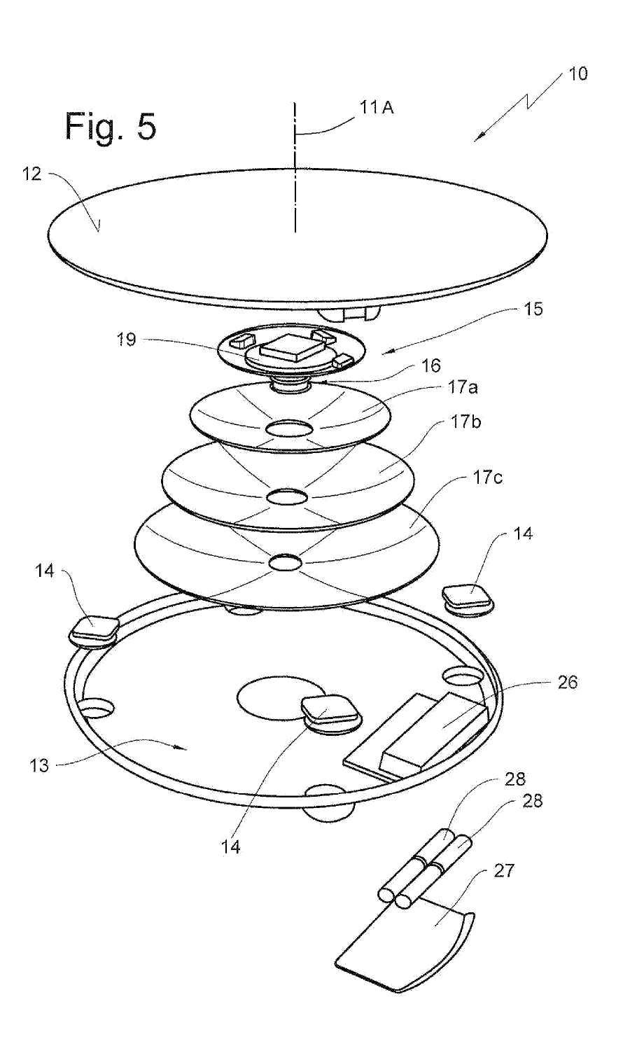

As shown in FIG. 5, a floor or base plate 13 of the housing 11 has an upstanding rim into which a circular outer edge of the platform 12 is set and also has a holder 26 together with a lid 27 for batteries 28.

The operation and structure of the apparatus 10 when weighing a person are explained below with reference to FIGS. 1 through 4.

In FIG. 1 the weighing apparatus 10 is shown in plan view with an assumed position of feet 29 of the person being weighed. Furthermore, the display module 22 can be seen shining through the translucent platform 12 as well as four touch zones 30 angularly equispaced around the center of the platform 12 above the touch sensors 21. The above-mentioned touch zones 30 can be actuated by a finger or toe.

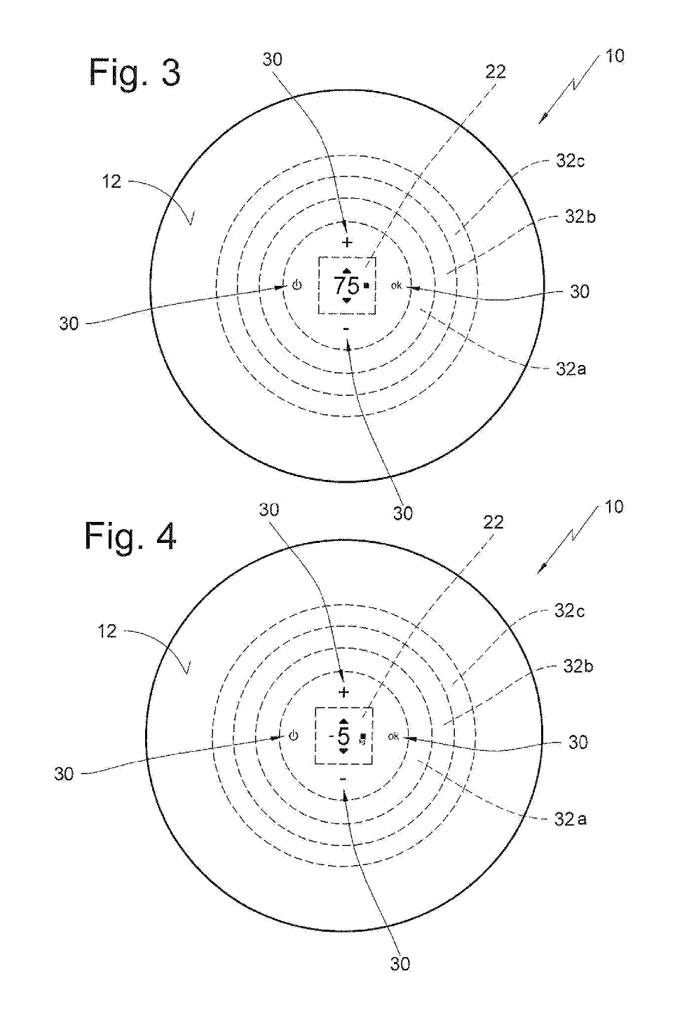

In principle, it is possible to initially define different users A, B, C or D for the same weighing apparatus 10 via the touch sensors 21/touch zones 20, as shown in FIG. 2.

According to FIG. 3, for example, user A can enter a target weight of 75 kg via the touch zones 30. Then as shown in FIG. 4, for example, when the sensors 14 report an actually measured weight of 70 kg, the value −5 appears on the display, that is, 5 kg less on the target value.

This is accomplished in that to start with the values measured by the weight sensors arranged in the feet 14 are sent to the circuit board 19 forming the apparatus' controller. A personal target weight has already been entered in its nonvolatile memory by the input apparatus formed by the touch zones 30. The circuit on the board 19 calculates the difference value and then displays it at 22 to show whether the actual weight is more or less than the personal target value. Depending on whether any deviation is up or down, light of different color can now be cast in the desired manner by the LEDs 24 into the respective optical light guides 17a, 17b, or 16c or 90° segments thereof. This light is reflected by upward from the regions 32a, 32b, and 32c and is visible through the platform. It is therefore possible to provide a large number of different light patterns to indicate various things to the user

I claim:

1. An apparatus for weighing a person, the apparatus comprising:
a platform;
at least one weight sensor connected to the platform for producing an output corresponding to a weight applied to the platform;
a display; and
control means connected to the sensor and to the display for comparing the output with a stored target value, for calculating a difference between the output and stored value, and for displaying data on the display corresponding to the calculated difference.

2. The weighing apparatus defined in claim 1 defined in claim 1 wherein the control means can store a plurality of the target values.

3. The weighing apparatus defined in claim 1 wherein the control means includes a plurality of touch sensors actuatable through the platform.

4. The weighing apparatus defined in claim 1 wherein the platform is at least partially transparent and the display includes:
a light source for emitting a beam of light; and
a light guide for deflecting the beam of light onto a lower face of the platform.

5. The weighing apparatus defined in claim 4 wherein there are a plurality of the light sources and a plurality of respective light guides.

6. The weighing apparatus defined in claim 5 wherein the light sources emit light of different colors.

7. The weighing apparatus defined in claim 5 wherein the platform is made of polycarbonate.

8. The weighing apparatus defined in claim 5 wherein each of the light guides has an upwardly concave upper surface turned toward the lower face of the platform.

9. The weighing apparatus defined in claim 5 wherein the light guides are basically circular and are of increasing diameter from an uppermost light guide to a lowermost light guide, whereby each light guide reflects a respective ring of light on

10. The weighing apparatus defined in claim 9 wherein the light guides are upwardly concave and the platform is downwardly concave.

11. The weighing apparatus defined in claim 10 wherein each of the light guides has a substantially circular outer periphery bearing upward on the lower face.

12. The weighing apparatus defined in claim 5 wherein there are three such light guides and three such sources, an uppermost source reflecting light from an uppermost light guide onto the lower face of the platform.

13. The weighing apparatus defined in claim 5 wherein the light source includes a stem extending vertically centrally through the light guides and carrying a plurality of vertically spaced arrays of radially outwardly directed light-emitting diodes, each array emitting light reflecting off a respective light guide.

14. The weighing apparatus defined in claim 13 wherein the stem is of square section and has four sides each carrying a respective one of the sources of each array.

15. The weighing apparatus defined in claim 13 wherein an upper end face of the stem is provided with a digital display.

16. The weighing apparatus defined in claim 14 wherein the stem carries a printed circuit constituting the control means.

17. The weighing apparatus defined in claim 16 further comprising
a data link for connection of the control means to a smartphone.

18. A method of weighing a person comprising the steps of:
storing a target weight value for a person;
weighing the person and determining a difference between an actual weight of the person and the target weight value;
optically displaying the difference to the person.

19. The method defined in claim 18, further comprising the step of
displaying to the person whether the difference represents a weight gain or a weight loss.
